(19) United States
(12) Patent Application Publication
(10) Pub. No.: US 2026/0167565 A1
(43) Pub. Date: Jun. 18, 2026

(54) INORGANIC NANO-COMPOSITE THERMAL INSULATION MATERIAL AND METHOD OF MANUFACTURE

(71) Applicant: Liatris Inc., Rockville, MD (US)

(72) Inventors: Arthur J. YANG, Rockville, MD (US); Tingxi Lu, Rockville, MD (US); Ishan N. Jayalath, Rockville, MD (US); Shu Xiong, Rockville, MD (US); Lida Lu, Rockville, MD (US)

(21) Appl. No.: 18/985,936

(22) Filed: Dec. 18, 2024

(51) Int. Cl. C04B 7/32; C04B 38/10; C04B 40/00; C04B 41/53; C04B 103/00; C04B 103/14; C04B 103/22; C04B 103/30; C04B 103/40; C04B 103/65; C04B 111/28

(52) U.S. Cl. CPC C04B 7/323; C04B 38/10; C04B 40/0042; C04B 41/5307; C04B 2103/0079; C04B 2103/14; C04B 2103/22; C04B 2103/304; C04B 2103/40; C04B 2103/65; C04B 2111/28

(57) ABSTRACT

In an example, the thermal insulation is prepared by blending water with the following ingredients including a hydraulic cement in an amount from about 5% to about 25% by weight, a reinforcing fillers including clays, sands, limestone powders, perlites, re-dispersible polymer powders, and fibers in an amount of from about 0% to 40% wt, foaming agents from about 0.02% to 4.0% wt, a rheological agent in an amount of about 0.05% to 4.0% wt, a curing accelerator in an amount of about 0.01% to 2.0% wt, a curing retarder in an amount of about 0.01% to 1.0% wt, and a water repellent agent in an amount of about 0.02% to 4.0% wt, wherein a secondary pore structure is created by mechanical frothing the mixture with air in an amount of about 20% to 80% by volume and the composite foam insulation is subsequently dried and cured in a mold.

### BACKGROUND OF INVENTION

This present invention describes a thermal insulation containing a porous inorganic cementitious composite and a method for its preparation. Merely by way of example, the invention can be applied to various applications such as residential buildings, commercial buildings, transportation (e.g., vehicles), industrial applications (e.g., pipes, boilers, and furnaces), aerospace, and appliances in financial, biotechnology, chemical, building, energy, technology, and others.

Conventional, thermal insulation is becoming more and more important nowadays because of the world's desperate needs of energy conservation to reduce global warming. Our major energy consumptions are in the office and home buildings (˜40%), industrials (˜33%), and transportations (˜27%). The broad application of thermal insulations could significantly raise the energy efficiency for the economy and is the only solution to save global environment due to its scale of impact. Unfortunately, limitations exist with conventional insulation, such as costs, effectiveness, and reliability.

From the above, techniques for improving thermal insulation are desirable.

### SUMMARY OF INVENTION

The present invention relates to a thermal insulation composite made with inorganic cementitious materials that exhibit nano structures with high porosity. The composite is prepared using a process which comprises the steps of mixing water with hydraulic cements, fillers, fibers, additives, foaming agent, and hydrophobizing agent; mechanically frothing (i.e. foaming) the mixture with air; casting the foamed mixture into molds; curing the foam in the molds; and final drying solution voids. The final composite exhibits a porosity of about 75% to 98%, a density in the range of about 0.05 to 0.70 g/cm³, a wide pore size distribution from about 50 nanometers to 500 microns, a compressive strength in the range of about 10 to 2000 psi, and a thermal conductivity in the range of 0.024 to 0.075 W/mK (R value in the range of about 2.0 to 6.0/inch). The composite also exhibits non-flammability, noise reduction, and high temperature endurance properties.

Scanning of electron microscopic study has shown two types of pores (FIGS. 4 and 5 above). The large pores (in the range of 50 to 500 microns) are created by mechanical frothing while smaller nanopores (in the range of 50 to 500 nanometers) is created by removing the pore-entrapped water by drying.

The present invention provides a thermal insulation composite formed from a mixture which utilizes a hydraulic cement in an amount of from about 5.0% to 25.0%, water in an amount from about 75.0% to 95.0%, a foaming agent in an amount from about 0.02% to 5.0%, a filling and reinforcing agent in an amount of about 0% to 40.0%, a rheological agent in an amount of 0.05% to 4.0% of the mixture, a curing accelerator in an amount of about 0.01% to 2.0%, a curing retarder in an amount of about 0.01% to 1.0%, and a water repellent agent in an amount of about 0.02% to 4.0%.

In addition, the present invention provides a method for producing the composite by mechanical frothing the mixture with air to form a foamed mixture. The desired expansion of the mixture by mechanical frothing is in a range of about 25% to 300% by volume of the original mixture. This method allows the formation of microcellular structure with cell sizes in the range of 50 to 500 microns after cement mixture hardening and drying as shown in scanning electron micrograph (FIG. 4). The porosity achieve through mechanical foaming is in the range of about 20% to 75%.

Furthermore, after cement mixture hardening there are extra water not utilized in the hardening process. Detailed study has shown that only a small fraction of hydration water is utilized in the cement hydration process. The majority of hydration water within the cellular walls can thus be removed by drying. Therefore, the nanopores within the cell walls are formed through drying with pore sizes in the range of about 50 nanometers to about 500 nanometers as shown in scanning electron micrograph (FIG. 5), which results in additional porosity in the range of about 25% to 90%. The combined porosity from macropores and nanopores is in the range of about 75% to about 98%.

A further understanding of the nature and advantages of the invention may be realized by reference to the latter portions of the specification and attached drawings.

### BRIEF DESCRIPTION OF THE DRAWINGS

In order to more fully understand the present invention, reference is made to the accompanying drawings. Understanding that these drawings are not to be considered limitations in the scope of the invention, the presently described examples and the presently understood best mode of the invention are described with additional detail through use of the accompanying drawings in which:

FIG. 1 is a simplified diagram that illustrates the first part of production schematics: Step 1—Adding water to a mixer followed by adding a mixture of cement and filler; Step 2—Mixing the batch while adding additional additives; Step 3—Introduction of air via a pump according to an example of the present invention.

FIG. 2 is a simplified diagram that illustrates the second part of the production schematics: Step 4—Froth the mixture while pumping more air; Step 5—Casting the frothed foamed cement into a mold; Step 6—hardening of the foam according to an example of the present invention.

FIG. 3 is a simplified diagram that illustrates the third part of the production schematics: Step 7—Demolding the cured foam; Step 8—Dry the foam; (cross-section of the dried foam showing microcellular foams) according to an example of the present invention.

FIG. 4 is the SEM micrograph of foamed cement at 500 UM (i.e. micron) scale bar according to an example of the present invention.

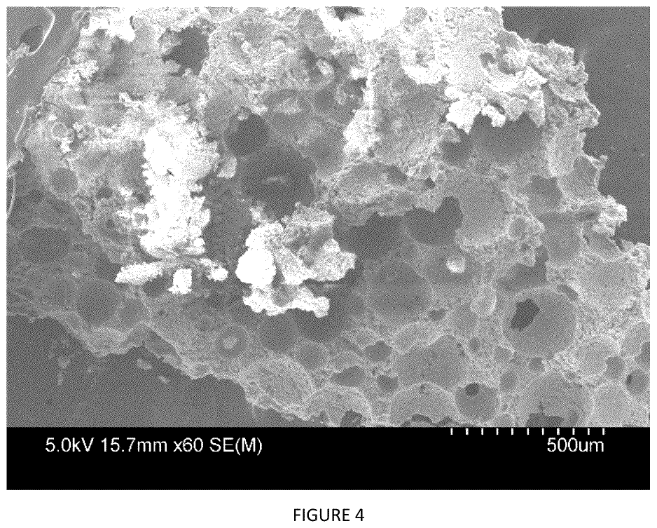

FIG. 5 is the SEM micrograph of foamed cement at 5.00 UM (i.e. micron) scale bar according to an example of the present invention.

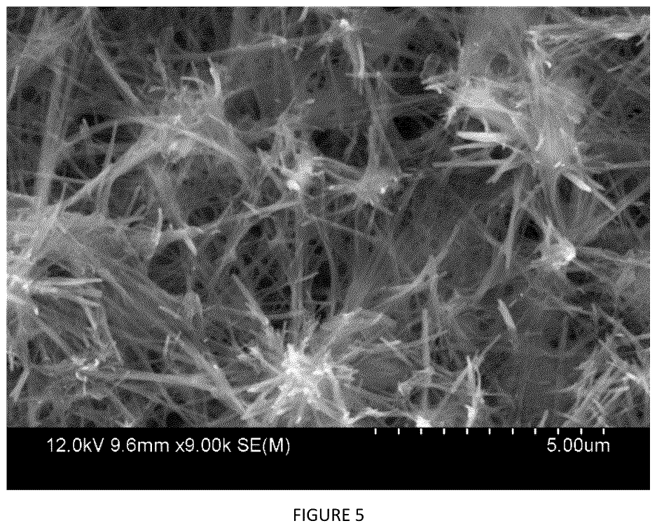

### DETAILED DESCRIPTION OF THE EXAMPLES

The present insulation market contains both organic and inorganic porous materials of which the selection are mostly based on installation ease or fire-resistance codes. The foamed polymers such as polyurethane foam, phenolic foam, foamed rubber, foamed polyolefin, foamed polystyrene (XPS and EPS) are typical organic foams. These polymeric foams have R value ranging from about 3.6/inch such as EPS to about 6.8/inch such as polyiso foam. These foams have been extensively used in the building thermal insulations. However, these insulations are highly combustible and also have limited upper use temperatures. Fiberglass and mineral wools are typical inorganic based thermal insulations and also used extensively in the building market. These inorganic insulation materials are non-flammable and has higher upper use temperatures than organic polymer insulations, but often inferior in fire and smoke ratings. Typically, less-flammable insulation has R value around R-3.2/inch which is much lower than organic polymer foams could offer (R-3.6 to 6.8/inch).

The foamed concrete offers the best combination of mechanical strength and non-flammability but with very poor insulation performances, typically in the range of R-0.2 to R-1.3/inch. Consequently, they are seldomly used as the primary thermal insulation layer. Recently, silica aerogel has gradually become a new generation of super insulation with inorganic nonflammability and low densities as well as high amount of mesopores (i.e. pores in nanometer scales) for much reduced thermal conductivities. Because of the mesoporous structure aerogel has achieved superior thermal insulation performances with R value reaching as high as R-12/inch. However, silica aerogel production required the removal of very large amount of solvent by sophisticated processing, such as solvent exchange or supercritical drying, that is too costly compared to conventional insulation manufacturing. Furthermore, performance deterioration due to moisture adsorbed by nanopore often required additional surface treatments of the finished product, adding more processing time and expenses. This invention discloses the production of a class of nonflammable, inorganic foams using concrete as a base material while incorporating both micropores by foaming and mesopores by drying solution voids into the composite, thereby accomplishing a nonflammable insulation with very high R-values.

In an example, the terms are defined below. Such terms are understood by their ordinary meaning, including the express definitions below.
“nm” means nanometer
“m” means meter
“cm” means centimeter
“ml” means milliliter
“%” means percent
“W” means watt, an energy unit
“psi” means pound per square inch
“g” means gram, a weight unit
“K” means kelvin, a temperature unit
“R” means thermal resistance
“XPS” means extruded polystyrene
“EPS” means expanded polystyrene
“CAC” means calcium aluminate cement
“CSA” means calcium sulfoaluminate cement
“rpm” means revolution per minute
“EX” means example
“PAN” means polyacrylonitrile
“NRC” means noise reduction coefficient
“hydraulic cement” generally means a cement will react with water
“a rheological agent” generally means an agent that will change the rheological behavior
“a curing retarder” generally means an agent that will retarding the reaction
a curing accelerator” and “hardening agent” generally means an agent that will accelerate the curing and hardening of a cement
“a water repellent agent” generally means an agent will repel the water
“an entrained air” generally means air encapsulated within the composite material
“a reinforcing agent” generally means an agent that will reinforce a composite material

Of course, the definitions defined above are merely for explanatory purposes. Further details of the present invention can be found throughout the present specification and more particularly below.

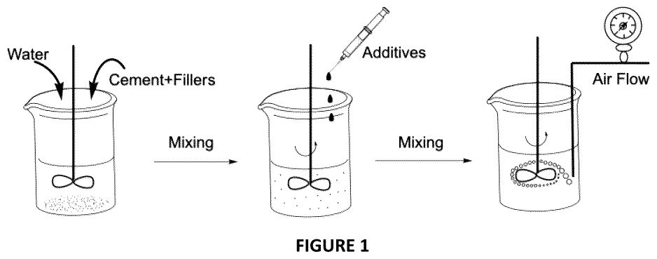

FIG. 1 is a simplified diagram that illustrates the first part of production schematics in an example of the present invention. As shown, Step 1 relates to adding water to a mixer followed by adding a mixture of cement and filler; Step 2 illustrates mixing the batch while adding additional additives; Step 3 illustrates Introduction of air via a pump according to an example of the present invention.

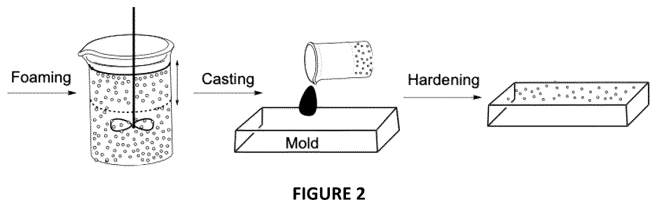

FIG. 2 is a simplified diagram that illustrates the second part of the production schematics according to an example of the present invention. Step 4 illustrates froth the mixture while pumping more air; Step 5 illustrates casting the frothed foamed cement into a mold; and Step 6 illustrates hardening of the foam according to an example of the present invention.

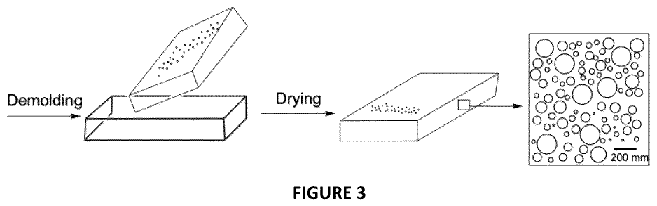

FIG. 3 is a simplified diagram that illustrates the third part of the production schematics according to an example of the present invention. As shown, Step 7 illustrates demolding the cured foam; and Step 8 illustrates drying the foam. A cross-section of the dried foam showing microcellular foams is also illustrated according to an example of the present invention.

Further details of the present technique can be found throughout the present specification and more particularly below.

The invention utilizes a hydraulic cement as a major binder to form the composite. There are many hydraulic cements that can be used to form the composites. The suitable cements include Portland cement (Type I, II, and III), a calcium aluminate cement (CAC), a calcium sulfoaluminate cement (CSA), a gypsum, a slag cement, Type K cement, a geopolymer cement, a phosphate cement, or other hydraulic cements. When the cement is added to the water it will slowly hydrate and produce a gel structure by forming various precipitated crystals. When hydration is completed the cement mixture is finally hardened. The preferred cement amount plus other solid contents is in the range of about 5% to 25% in the mixture, while water is in the range of 75% to 95%.

A foaming agent is further added to the cement water mixture in a range from about 0.02% to 5.0%. The mixture is then frothed with air mechanically to expand the mixture volume. The mixture volume expansion can be controlled in the range of about 25% to 300%. The preferred expansion by volume is in the range of 50% to 200%. The foaming agents are typically surfactants that are capable to foam the aqueous mixture. Suitable surfactants include sodium sulfate (SLS), sodium laureth sulfaten (SLES), sodium trideceth sulfate, sodium dodecyl sulfate (SDS), sodium methyl cocoyl taurate, sodium C14-16 olefin sulfonate, PEG-12 dimethicone, decyl glucoside, coco glucoside, glycolipids, sodium cocoamphoacetate, oleamide DEA, cocamide DEA, cocamide MEA, cocamide methyl MEA, kernelamide MEA, cocamidopropylamine oxide, zwitterionic lauramidopropyl betaine, cocamidopropyl betaine, coco-betaine, cocamidopropyl hydroxysultaine, cetrimonium bromide, cetrimonium chloride, PEG-3 lauramide, PEG-5 cocamide, fatty alkanolamide, fatty acid, capryloyl/caproyl methyl glucamide, Quillaja Saponaria, TEA-cocoyl sarcosinate, triethanolamine lauryl sulfate, or any combinations thereof. The preferred amount of foaming agents to froth the mixture is in a range from 0.02% to 5.0%.

Various fillers, reinforce agents, and additives can be added to the cement mixture to obtain various desired composite properties such as improved compressive strength, flexural strength, impact resistance and toughness, reduced shrinkage and cracking, and handleability. The preferred amount of fillers and reinforce agents is in the range of from 0% to 40% of total solid content. Suitable fillers and reinforce agents include sand, limestone, kaolin, perlite, silica aerogel, bentonite, sepiolite, attapulgite, talc, silica, fiberglass, cellulose fiber, nanocellulose, olefin fiber, polyester fiber, PAN fiber, redispersible polymer powders, or any combinations thereof. When fibers are added the preferred fibers are short fibers with fiber length in the range of 1 to 20 millimeters, most preferably in the range of 2 to 8 millimeters.

A rheological agent is used in one example to improve the slump resistance, workability, applicability, water retention, and foam stability. The preferred amount of rheological agent is in the range of about 0.05% to 4.0%. Typical rheological agent comprises cellulose derivative thickeners such as carboxylmethylcellulose (CMC), ethylcellulose (EC), hydroxyethylceullulose (HEC), hydroxylpropylcellulose (HPC), hydroxypropylmethylcellulose (HPMC), Polyvinyl alcohol, starch derivatives such as dextrin and hydroxypropyl starch phosphate, xanthan, guars, sodium polyacrylic acid, fumed silica, or any combinations thereof. Examples of suitable thickeners are Walocel CRT 10000 G, Cellosize ER 15M, Methocel 228S, Natrosol 250MR, Esacol HD 15, Esacol ED 133, etc.

In another example, cement curing modification agents are utilized including curing retarders and accelerators. The retarders are used in the cement mixture to delay the cement setting and hardening time so that the cement mixture will have a stable workable rheology during processing. Desirable amount of retarder will provide a working window for the mixing, pumping, and casting. The preferred amount of retarder is in the range of about 0% to 1.0%. Typical cement retarder is selected from citric acid, sodium citrate, sodium gluconate, sodium tartrate, hydroxycarboxylic acids and their salts, phosphonate, calcium sulfate, sugar, lignosulfonic acid, borates, or any combinations thereof.

In addition, accelerators are used along with retarders to speed up the setting and hardening time of the cement mixture once retarders are consumed. When an ideal (or desirable) amount of retarders and accelerators are used the cement mixture will have proper working window during processing and then harden quickly once casted into the mold. The preferred amount of cement accelerator is in the range of about 0.01% to 2.0%. Typical cement accelerator is selected from lithium carbonate, sodium carbonate, calcium hydroxide, calcium silicate, calcium chloride, or any combinations thereof.

In one more example, a water repellent agent is used to improve the water resistance of the composite. As one of the applications of the composite is targeted to the building construction market for using as insulated wall panels and roofings. In these types of applications an exterior coating layer is applied to protect the insulation panels from rain water penetration. Water resistant composites will provide additional water resistance in case the exterior coating layer failed. There are many types of water repellents that are suitable for the application. Most common water repelling materials are the hydrophobic in nature. These include low melting wax emulsions such as Aquabead 270E from Micropowders, polysiloxane and silane derivatives such as Silrez BS 1802 from Wacker, silicones such as AP 0282 from Advanced Polymer, fluorinated compounds such as Capstone FS 35 from Chemours calcium stearate, fatty acid, or any combinations thereof. These materials can be added into the mixture during mixing. Once the composite is dried the hydrophobic moiety of the repellent could coat the interior surfaces of the composite. Thus, the composite exhibits hydrophobicity and repels water. The preferred amount of water repellent is in the range of about 0.02% to 4.0%.

Alternatively, hydrophobicity can also be achieved by applying the water repellent onto the surfaces of the composite. For example, a diluted polysiloxane emulsion can be sprayed onto the composite surfaces and dried in air so that the composite surface will exhibit water repellency.

Various processing methods can be used to manufacture the composite. One conventional process is to use a mixing vessel with a mixing blade to make a frothed cement mixture by mixing liquids and solid powder at adequate mixing speed, followed by injecting air into the mixture via an air pump to achieve desired volume of the foamed mixture. High mixing speed in the range of 500 to 5000 rpm is preferred to obtain finer foam cell size in the mixture. The frothed mixture is then pumped into a mold. Mixture in the mold will then harden with time. The hardening can be accelerated by aging the mold into an oven or an autoclave. The hardening will take place for few hours to several days depending on the cement composition and curing temperature. Once mixture is completely hardened the wet composite will be demolded and dried either at room temperature or in an oven. Optionally the wet composite can also be dried in the mold and demolded after drying.

The frothing can also be done via other methods such as an extruder, a static mixer, or a pressurized air nozzle. In this method the wet mixture and air at a predetermined mixing ratio can be feed into the extruder, the static mixer, or the air nozzle. Air can also feed into the extruder or the static mixer separately. The frothed mixture can be directly feed into a mold for curing.

### Example 1

All dry ingredients are mixed well in a container first. In this example 100 g Rapid Set CSA cement, 0.28 g lithium carbonate, 8.41 g hydroxypropylmethylcellulose (HPMC) medium molecular weight cellulose, 0.14 g citric acid, and 16.75 g clay are added to a container and mixed well. A second container with 798.40 g water is placed under a dispersing mixer. The premixed dry powder is then slowly added to the container with water under adequate mixing and mixed uniformly without any lumps. The mixture is then poured into a mold to let it set/cure briefly. The pre-set mixture is further cured at 50 Celsius for 12 hours. The cured sample is demolded and dried at 95 Celsius. The dried sample exhibits a density of 0.20 g/cm³ and thermal conductivity of 0.051 W/mK (i.e. R-2.82/inch).

TABLE I
Compositions and properties of nanocomposite examples

| Ingredients | EX1 | EX2 | EX3 | EX4 | EX5 | EX6 | EX7 |
|---|---|---|---|---|---|---|---|
| CSA cement | 100.00 | 100.00 | 100.00 | 100.00 | 100.00 | 100.00 | 100 |
| Lithium Carbonate | 0.28 | 0.28 | 0.29 | 0.28 | 0.25 | 0.28 | 0.28 |
| HPMC cellulose | 8.41 | 8.41 | 8.46 | 8.40 | 5.00 | 8.41 | 6.40 |
| Citric Acid | 0.14 | 0.14 | 0.15 | 0.15 | 0.25 | 0.14 | 0.14 |
| Clay | 16.75 | 16.75 | 12.18 | 12.00 | 11.96 | 12.18 | 8.68 |
| Cellulose fiber | — | — | 5.02 | — | — | 5.02 | — |
| PAN fiber | — | — | — | 5.02 | — | — | — |
| Fiberglass | — | — | — | — | 5.18 | — | — |
| Silica aerogel | — | — | — | — | — | — | 167.00 |
| granule | | | | | | | |
| Water | 798.40 | 798.40 | 801.00 | 801.00 | 797.40 | 801.00 | 422.00 |
| Sodium lauryl | — | 8.50 | 8.50 | 8.50 | 8.50 | 8.50 | 4.48 |
| sulfate (30%) | | | | | | | |
| Polysiloxane | — | — | — | — | — | 5.00 | — |
| powder | | | | | | | |
| Air (ml) | 0 | Ca 1000 | Ca 1000 | Ca 1000 | Ca 1000 | Ca 1000 | Ca 510 |
| Density (g/cm³) | 0.20 | 0.10 | 0.10 | 0.10 | 0.09 | 0.10 | 0.16 |
| Compressive | — | 14.00 | 29.00 | — | — | — | — |
| strength (PSI) | | | | | | | |
| Thermal | 0.051 | 0.036 | 0.035 | 0.035 | 0.034 | — | 0.026 |
| conductivity | | | | | | | |
| (W/mK) | | | | | | | |
| R value (per inch) | 2.82 | 3.98 | 4.08 | 4.05 | 4.17 | — | 5.53 |
| NRC | — | — | — | 0.40 | — | — | — |

### Example 2

In this example the cement mixture is made similarly to Example 1 except that the mixture is further foamed mechanically. The batch compositions and properties are shown in Table I. Here 8.50 g sodium lauryl sulfate (30%) is added to the second container together with 798.40 g water and mixed well. The dry powder premix is then slowly added to the second container under adequate mixing to obtain a uniform mixture. Air is then injected into the mixture during mixing by means of an air pump. The mixture is slowly frothed up to a desired volume. About 1000 ml air is used to foam the mixture to a desired volume. The foamed mixture is then molded, cured, and finally dried. This sample has shown a density of 0.09 g/cm³ and thermal conductivity of 0.036 W/mK (i.e. R-3.98/inch).

This example has clearly shown that mechanical frothing can further reduce the final foam density to achieve lower thermal conductivity.

### Examples 3 to 7

Examples 3 to 7 are carried out similar to Example 2 except that a cellulose fiber is added in Example 3, a PAN fiber is added in Example 4, a Fiberglass is added in Example 5, a polysiloxane water repellent is added in Example 6, and a hydrophobic silica aerogel is added in Example 7. Their compositions and properties have been shown in Table I. The nanocomposites made from Example 3, 4, and 5 have shown improved mechanical properties and higher R values with addition of a cellulose fiber, a polyacrylonitrile fiber, and a fiberglass respectively. The nanocomposite made from Example 4 has shown high noise reduction coefficient (NRC) at 0.40. The nanocomposite made from Example 6 has shown water beading properties by internal hydrophobization. The nanocomposite made from Example 7 has shown improved R value (R-5.53/inch) by incorporation of a silica aerogel.

In an example, the present invention provides a porous cement based thermal insulation composite material. The material comprises a dried composite material characterized by a porosity of about 80-97% and a thermal conductivity from about 0.036-0.014 W/mK (i.e. R value from 4-10/inch), and is characterized by a non-flammable inorganic material. In an example, the dried composite material is provided from a mixture comprises a hydraulic cement characterized by an amount from about 5% to 25% of weight in the mixture, and a water content characterized by an amount of from about 75% to 95% of weight in the mixture. The mixture includes a foaming agent characterized by an amount of about 0.02% to 5.0% of the mixture, a filling and reinforcing agent characterized by an amount of about 0% to 40% of the mixture, a rheological agent characterized by an amount of 0.05% to 4.0% of the mixture, a curing retarder characterized by an amount of about 0% to 1.0% of the mixture, a curing accelerator (i.e. hardening agent) characterized by an amount of about 0% to 2.0% of the mixture, a water repellent agent characterized by an amount of about 0% to 4.0% of the mixture, and an entrained air characterized by an amount of about 20%-75% by volume of a volume of the material. Of course, there can be variations.

In an example, the hydraulic cement comprises one or more of a Portland cement (Type I, II, and III), a calcium aluminate cement (CAC), a calcium sulfoaluminate cement (CSA), a gypsum, a slag cement, Type K cement, a phosphate cement, or a geopolymer cement, among others. In an example, the foaming agent comprises one or more surfactants that are capable to cause a froth in the mixture. In an example, the foaming agent comprises one or more of a sodium, potassium, or ammonium salts of lauryl and laureth sulfate, a sodium dodecyl sulfate (SDS), a decyl glucoside, a Quillaja Saponaria, a coco glucoside, a sodium cocoamphoacetate, a oleamide DEA, a cocamide DEA, a cocamide MEA, a cocamidopropylamine oxide, a zwitterionic cocamidopropyl betaine, or a cocamidopropyl hydroxysultaine, among others. In an example, the filling and reinforcing agent comprises at least one or more of a sand, a limestone, a kaolin, a perlite, a silica a aerogel, a bentonite, a sepiolite, a attapulgite, a talc, a silica, a fiberglass, a cellulose fiber, a olefin fiber, a polyester fiber, a PAN fiber, or a redispersible polymer powders, among others. In an example, the rheological agent comprises at least one or more of a cellulose derivative thickeners, including one or more of a carboxylmethylcellulose (CMC), a ethylcellulose (EC), a hydroxyethylceullulose (HEC), a hydroxylpropylcellulose (HPC), a hydroxypropylmethylcellulose (HPMC), a polyvinyl alcohol, a starch derivatives, including one or more of a dextrin and hydroxypropyl starch phosphate, a xanthan, a sodium polyacrylic acid, or any combinations thereof, among others,

In an example, the mixture a cement curing agent comprising a retarder and an accelerator. In an example, the curing retarder is selected from at least one or more of a citric acid, a sodium citrate, a sodium gluconate, a sodium tartrate, a hydroxycarboxylic acid and a salt, a phosphonate, a calcium sulfate, a sugar, a lignosulfonic acid, a borate, or any combinations thereof, among others. In an example, the curing accelerator is selected from at least one or more of a lithium carbonate, a sodium carbonate, a calcium hydroxide, a calcium silicate, a calcium chloride, or any combinations thereof, among others. In an example, the water repellent agent comprises one or more of a low melting wax, a polysiloxane, a silane derivative, a calcium stearate, a fatty acid, a fluorine containing compound, or any combinations thereof, among others.

In an example, the material comprises an enclosure configured to seal the material under a vacuum environment such that the material is characterized by a thermal conductivity of 0.012 W/mK and less and an R value of 12/inch or higher.

In an example, the present invention provides a method of fabricating a cement based thermal insulation composite material. The method includes providing a water. The method includes providing a foaming agent, a rheological agent, and a water repellent. The method includes combining the water with the foaming agent, the rheological agent, and the water repellent. In an example, the method includes mixing the water with the foaming agent, the rheological agent, and the water repellent to form a homogeneous solution. The method includes adding a pre-blend dry powder to the homogeneous solution, the pre-blended dry power comprising a cement, a filling and reinforcing agent, a cement curing retarder, a cement curing accelerator and further mixing the pre-blend dry power with the homogeneous solution to form a resulting mixture. In an example, the method includes Injecting a gas into the resulting mixture to cause a froth the resulting mixture causing formation of a foamed mixture characterized by a volume increase from about 25% to about 300%. In an example, the method includes transferring the foamed mixture into a recessed region and causing the foamed mixture to set and harden at temperature from room temperature to about 80 Celsius to form a shaped cement block. In an example, the method includes removing the shaped cement block and fully drying the shaped cement block from room temperature to about 150 Celsius until fully dried.

In an example, the adding is performed at a rate of 1% of a batch per minute to 25% of a batch per minute. In an example, the gas comprises an air. In an example, the injecting is provided using an air pump. In an example, the froth is provided by a dispersion mixer, a homogenizer, an extruder, a static mixer, or a pressurized air nozzle. In an example, the transferring is provided by a pouring, filling, pumping, or injection action, among others. In an example, the recessed region is characterized as a mold.

In an example, the present invention provides an alternative method of fabricating a cement device. The method includes providing a water. The method includes providing a foaming agent, a rheological agent, and a water repellent. The method includes combining the water with the foaming agent, the rheological agent, and the water repellent in a vessel. In an example, the method includes mixing the water with the foaming agent, the rheological agent, and the water repellent to form a homogeneous solution. In an example, the method includes adding a pre-blend dry powder to the homogeneous solution, the pre-blended dry power comprising a cement, a filling and reinforcing agent, a cement curing retarder, a cement curing accelerator and further mixing the pre-blend dry power with the homogeneous solution to form a resulting mixture. In an example, the method includes injecting a gas into the resulting mixture to cause a froth the resulting mixture causing formation of a foamed mixture characterized by a volume increase from about 25% to about 300%. The method includes transferring the foamed mixture into a recessed region configured as a shaped block and causing the foamed mixture to set and harden at temperature from room temperature to about 80 Celsius to form a shaped cement block within the recessed region. In an example, the method includes removing the shaped cement block from the recessed region and fully drying the shaped cement block from room temperature to about 150 Celsius until fully dried.

In an example, recessed region is configured in a mold.

While the above is a full description of the specific examples, various modifications, alternative constructions, and equivalents may be used. As an example, the present system, method, and device can include any combination of elements described above, as well as outside of the present specification. In an example, the terms first, second, third, and final do not imply order in one or more of the present examples. Therefore, the above description and illustrations should not be taken as limiting the scope of the present invention which is defined by the appended claims.

We claim:

1. A porous cement based thermal insulation composite material, the material comprising:
a dried composite material characterized by a porosity of about 80-97% and a thermal conductivity from about 0.036-0.014 W/mK (i.e. R value from 4-10/inch), and is characterized by a non-flammable inorganic material;
whereupon the dried composite material is provided from a mixture comprising:
a hydraulic cement characterized by an amount from about 5% to 25% of weight in the mixture, and a water content characterized by an amount of from about 75% to 95% of weight in the mixture;
a foaming agent characterized by an amount of about 0.02% to 5.0% of the mixture;
a filling and reinforcing agent characterized by an amount of about 0% to 40% of the mixture;
a rheological agent characterized by an amount of 0.05% to 4.0% of the mixture;
a curing retarder characterized by an amount of about 0% to 1.0% of the mixture;
a curing accelerator (i.e. hardening agent) characterized by an amount of about 0% to 2.0% of the mixture;
a water repellent agent characterized by an amount of about 0% to 4.0% of the mixture; and
an entrained air characterized by an amount of about 20%-75% by volume of a volume of the material.

2. The material of claim 1, wherein the hydraulic cement comprises one or more of a Portland cement (Type I, II, and III), a calcium aluminate cement (CAC), a calcium sulfoaluminate cement (CSA), a gypsum, a slag cement, Type K cement, a phosphate cement, or a geopolymer cement.

3. The material of claim 1, wherein the foaming agent comprises one or more surfactants that are capable to cause a froth in the mixture.

4. The material of claim 3, wherein the foaming agent comprises one or more of a sodium, potassium, or ammonium salts of lauryl and laureth sulfate, a sodium dodecyl sulfate (SDS), a decyl glucoside, a Quillaja Saponaria, a coco glucoside, a sodium cocoamphoacetate, a oleamide DEA, a cocamide DEA, a cocamide MEA, a cocamidopropylamine oxide, a zwitterionic cocamidopropyl betaine, or a cocamidopropyl hydroxysultaine.

5. The material of claim 1, wherein the filling and reinforcing agent comprises at least one or more of a sand, a limestone, a kaolin, a perlite, a silica a aerogel, a bentonite, a sepiolite, a attapulgite, a talc, a silica, a fiberglass, a cellulose fiber, a olefin fiber, a polyester fiber, a PAN fiber, or a redispersible polymer powders.

6. The material of claim 1, wherein the rheological agent comprises at least one or more of a cellulose derivative thickeners, including one or more of a carboxylmethylcellulose (CMC), a ethylcellulose (EC), a hydroxyethylceullulose (HEC), a hydroxylpropylcellulose (HPC), a hydroxypropylmethylcellulose (HPMC), a polyvinyl alcohol, a starch derivatives, including one or more of a dextrin and hydroxypropyl starch phosphate, a xanthan, a sodium polyacrylic acid, or any combinations thereof.

7. The material of claim 1, further comprising a cement curing agent comprising a retarder and an accelerator.

8. The material of claim 1, wherein the curing retarder is selected from at least one or more of a citric acid, a sodium citrate, a sodium gluconate, a sodium tartrate, a hydroxycarboxylic acid and a salt, a phosphonate, a calcium sulfate, a sugar, a lignosulfonic acid, a borate, or any combinations thereof.

9. The material of claim 1, wherein the curing accelerator is selected from at least one or more of a lithium carbonate, a sodium carbonate, a calcium hydroxide, a calcium silicate, a calcium chloride, or any combinations thereof.

10. The material of claim 1, wherein the water repellent agent comprises one or more of a low melting wax, a polysiloxane, a silane derivative, a calcium stearate, a fatty acid, a fluorine containing compound, or any combinations thereof.

11. The material of claim 1, further comprising an enclosure configured to seal the material under a vacuum environment such that the material is characterized by a thermal conductivity of 0.012 W/mK and less and an R value of 12/inch or higher.

12. A method of fabricating a cement based thermal insulation composite material, the method comprising:
providing a water;
providing a foaming agent, a rheological agent, and a water repellent;
combining the water with the foaming agent, the rheological agent, and the water repellent;
mixing the water with the foaming agent, the rheological agent, and the water repellent to form a homogeneous solution;
adding a pre-blend dry powder to the homogeneous solution, the pre-blended dry power comprising a cement, a filling and reinforcing agent, a cement curing retarder, a cement curing accelerator and further mixing the pre-blend dry power with the homogeneous solution to form a resulting mixture;
Injecting a gas into the resulting mixture to cause a froth the resulting mixture causing formation of a foamed mixture characterized by a volume increase from about 25% to about 300%;
transferring the foamed mixture into a recessed region;
causing the foamed mixture to set and harden at temperature from room temperature to about 80 Celsius to form a shaped cement block;
removing the shaped cement block; and
fully drying the shaped cement block from room temperature to about 150 Celsius until fully dried.

13. The method of claim 11 wherein the adding is performed at a rate of 1% of a batch per minute to 25% of a batch per minute.

14. The method of claim 11 wherein the gas comprises an air.

15. The method of claim 11 wherein the injecting is provided using an air pump.

16. The method of claim 11 wherein the froth is provided by a dispersion mixer, a homogenizer, an extruder, a static mixer, or an pressurized air nozzle.

17. The method of claim 11 wherein the transferring is provided by a pouring, filling, pumping, or injection action.

18. The method of claim 11 wherein the recessed region is characterized as a mold.

19. A method of fabricating a thermal insulation material, the method comprising:
providing a water;
providing a foaming agent, a rheological agent, and a water repellent;
combining the water with the foaming agent, the rheological agent, and the water repellent in a vessel;
mixing the water with the foaming agent, the rheological agent, and the water repellent to form a homogeneous solution;
adding a pre-blend dry powder to the homogeneous solution, the pre-blended dry power comprising a cement, a filling and reinforcing agent, a cement curing retarder, a cement curing accelerator and further mixing the pre-blend dry power with the homogeneous solution to form a resulting mixture;
injecting a gas into the resulting mixture to cause a froth the resulting mixture causing formation of a foamed mixture characterized by a volume increase from about 25% to about 300%;
transferring the foamed mixture into a recessed region configured as a shaped block;
causing the foamed mixture to set and harden at temperature from room temperature to about 80 Celsius to form a shaped block within the recessed region;
removing the shaped cement block from the recessed region; and
fully drying the shaped block from room temperature to about 150 Celsius until fully dried.

20. The method of claim 1 wherein recessed region is for a mold.
